(19) United States
(12) Patent Application Publication
(10) Pub. No.: US 2021/0066903 A1
(43) Pub. Date: Mar. 4, 2021

(54) CABLE ORGANIZER

(71) Applicant: DONGGUAN XUNTAO ELECTRONIC CO., LTD., Qingxi Town Dongguan City (CN)

(72) Inventors: LinBiao HU, Dongguan City (CN); Hua YI, Dongguan City (CN); ZuoHua HUANG, Dongguan City (CN)

(73) Assignee: DONGGUAN XUNTAO ELECTRONIC CO., LTD., Qingxi Town Dongguan City (CN)

(21) Appl. No.: 16/809,021

(22) Filed: Mar. 4, 2020

(30) Foreign Application Priority Data
Sep. 2, 2019 (CN) 201921446400.X

(51) Int. Cl. H02G 11/02; H02J 7/00; H01R 13/72

(52) U.S. Cl. CPC H02G 11/02; H01R 13/72; H02J 7/0045

(57) ABSTRACT

The present disclosure provides a cable organizer comprising a body, a charger, and an electrical connecting cable. The body comprises a first accommodating slot, an annular groove, and a first communicating hole. The annular groove is disposed on the first accommodating slot. The first accommodating slot connects to the annular groove through the first communicating hole. The charger is disposed in the first accommodating slot. One end of an electrical connecting cable is electrically connected to the charger. The electrical connecting cable enters the annular groove through the first communicating hole. The electrical connecting cable is wound around the body and is stored in the annular groove. Therefore, the electrical connecting cable can be neat and tidy, and to be easily stored.

### CROSS REFERENCE TO RELATED APPLICATION

This application claims the priority benefit of Chinese Patent Application Serial Number 201921446400.X, filed on Sep. 2, 2019, the full disclosure of which is incorporated herein by reference.

### BACKGROUND

### Technical Field

The present disclosure relates to an organizer, and more particularly to a cable organizer.

### Related Art

Traditionally, chargers and transmission cables are usually separate accessories. To charge the electronic device with the charger, it only needs to plug one end of the transmission cable into the charger. However, the charger and the transmission cable are generally separately stored, so that one of the charger and the transmission cable is easily lost. While the transmission cable is stored, the transmission cable is not secured and is prone to disorder, and sometimes the knotting of the transmission cable bothers while it is being used.

### SUMMARY

The present disclosure provides a cable organizer dealing with the issue that one of the charger and the transmission cable is easily lost when the conventional charger and the transmission cable are separately stored.

The present disclosure provides a cable organizer comprising a body, a charger and an electrical connecting cable. The body comprises a first accommodating slot, an annular groove, and a first communicating hole. The annular groove is disposed along the circumference of the first accommodating slot. The first accommodating slot connects to the annular groove through the first communicating hole. The charger is disposed in the first accommodating slot. One end of an electrical connecting cable is electrically connected to the charger. The other end of the electrical connecting cable enters the annular groove from the first communicating hole. The electrical connecting cable is wound around the body and is stored in the annular groove.

The embodiments of the present disclosure store the charger in the first accommodating slot and wind the electrical connecting cable around the body and store it in the annular groove, so the electrical connecting cable can be neatly arranged without being scattered and easy to be stored.

It should be understood, however, that this summary may not contain all aspects and embodiments of the present invention, that this summary is not meant to be limiting or restrictive in any manner, and that the invention as disclosed herein will be understood by one of ordinary skill in the art to encompass obvious improvements and modifications thereto.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 is a schematic diagram of a cable organizer of the first embodiment of the present disclosure;

FIG. 2 is another schematic diagram of a cable organizer of the first embodiment of the present disclosure;

FIG. 3 is a cross-sectional view of a cable organizer of the first embodiment of the present disclosure;

FIG. 4 is an exploded view of a cable organizer of the first embodiment of the present disclosure;

FIG. 5 is a state diagram of the use of a cable organizer of the first embodiment of the present disclosure;

FIG. 6 is another state diagram of the use of a cable organizer of the first embodiment of the present disclosure;

FIG. 7 is a state diagram of charging of a cable organizer of the first embodiment of the present disclosure;

FIG. 8 is a schematic diagram of a cable organizer of the second embodiment of the present disclosure; and

FIG. 9 is a state diagram of the use of a cable organizer of the second embodiment of the present disclosure.

### DETAILED DESCRIPTION OF THE EMBODIMENTS

The present invention will now be described more fully hereinafter with reference to the accompanying drawings, in which exemplary embodiments of the invention are shown. This present invention may, however, be embodied in many different forms and should not be construed as limited to the embodiments set forth herein. Rather, these embodiments are provided so that this present invention will be thorough and complete, and will fully convey the scope of the present invention to those skilled in the art.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substantial/substantially” means, within an acceptable error range, the person skilled in the art may solve the technical problem in a certain error range to achieve the basic technical effect.

The following description is of the best-contemplated mode of carrying out the invention. This description is made for the purpose of illustration of the general principles of the invention and should not be taken in a limiting sense. The scope of the invention is best determined by reference to the appended claims.

Moreover, the terms “include”, “contain”, and any variation thereof are intended to cover a non-exclusive inclusion. Therefore, a process, method, object, or device that includes a series of elements not only include these elements, but also includes other elements not specified expressly, or may include inherent elements of the process, method, object, or device. If no more limitations are made, an element limited by “include a/an . . . ” does not exclude other same elements existing in the process, the method, the article, or the device which includes the element.

In the following embodiment, the same reference numerals are used to refer to the same or similar elements throughout the invention.

In the following embodiments, the same or similar elements will be indicated by the same reference numerals.

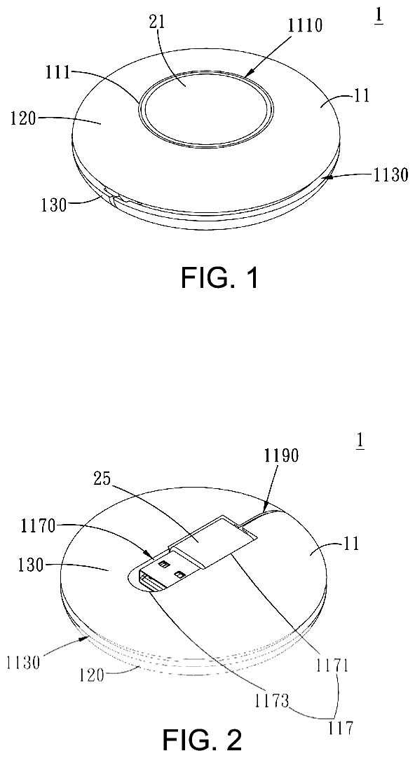

FIG. 1 to FIG. 3 are the schematic diagram, another schematic diagram and a cross-sectional view of a cable organizer of the first embodiment of the present disclosure. As shown in the figure, the present disclosure provides a cable organizer 1 for accommodating a charger 21 and an electrical connecting cable 23. The cable organizer 1 comprises a body 11, a charger 21 and an electrical connecting cable 23. The body 11 comprises a first accommodating slot 111, an annular groove 113, and a first communicating hole 115. The annular groove 113 is disposed along the circumference of the first accommodating slot 111 so that the body 11 of the present embodiment is divided into three sections of an intermediate winding body 110, the first annular part 120 and the second annular part 130 by the first accommodating slot 111 and the annular groove 113. The first accommodating slot 111 is disposed in the intermediate winding body 110. The annular groove 113 is disposed between the first annular part 120 and the second annular part 130.

As described above, the first accommodating slot 111 connects to the annular groove 113 through the first communicating hole 115. In this embodiment, the first communicating hole 115 is disposed on the inner wall of the first accommodating slot 111. The first accommodating slot 111 comprises a first slot opening 1110 disposed at the top surface of the body 11. That is, the first annular part 120 surrounds the first slot opening 1110. The annular groove 113 comprises an annular opening 1130 disposed at the circumferential side of the body 11. The annular opening 1130 is disposed around the first slot opening 1110, that is, in between the circumference of the first annular part 120 and the circumference of the second annular part 130.

FIG. 4 is an exploded view of a cable organizer of the first embodiment of the present disclosure. One end of the electrical connecting cable 23 is electrically connected to the charger 21. The other end of the electrical connecting cable 23 is electrically connected to the electrical connector 25.

The length and width of the cross-sectional area of the electrical interface of the electrical connector 25 in the insertion direction is smaller than or equal to the orifice of the first communicating hole 115. Pass one end of the electrical connecting cable 23 having electrical connector 25 through the first communicating hole 115 into the annular groove 113. The charger 21 is then disposed in the first accommodating slot 111, and the electrical connecting cable 23 winds the intermediate winding body 110 of the body 11 while the electrical connector 25 and the electrical connecting cable 23 passes through the annular opening 1130 of the annular groove 113, such that the electrical connecting cable 23 can be neatly stored in the annular groove 113.

In this embodiment, the inner part of the charger 21 comprises a wireless charging coil 211 and a circuit board 213, in which the wireless charging coil 211 is electrically connected to the circuit board 213. The wireless charging coil 211 is disposed close to the first slot opening 1110 of the first accommodating slot 111. One end of the electrical connecting cable 23 is electrically connected to the circuit board 213 of the charger 21.

Furthermore, in this embodiment, the first accommodating slot 111 of the body 11 is cylindrical, and the charger 21 is also cylindrical. The inner diameter of the first slot opening 1110 of the first accommodating slot 111 is greater than or equal to the outer diameter of the charger 21. The height of the first accommodating slot 111 is higher than or equal to the height of the charger 21 so that the charger 21 can be stored in the first accommodating slot 111.

In another embodiment, the body 11 further comprises a second accommodating slot 117 and a second communicating hole 119. The second accommodating slot 117 comprises a second slot opening 1170 disposed on the bottom surface of the body 11. That is, the second ring part 130 surrounds the second slot opening 1170. The second accommodating slot 117 connects to the annular groove 113 through the second communicating hole 119. In this embodiment, the second communicating hole 119 is on the inner wall of the second accommodating slot 117. The cross-sectional area of the electrical interface of the electrical connector 25 in the insertion direction is less than or equal to the orifice of the second communicating hole 119. The electrical connector 25 is disposed in the second accommodating slot 117. The electrical connecting cable 23 closed to the electrical connector 25 is disposed in the second communicating hole 119. Moreover, the second slot opening 1170 of the second accommodating slot 117 is greater than or equal to the largest side surface area of the electrical connector 25. The height of the second accommodating slot 117 is greater than or equal to the height of the electrical connector 25 in a direction perpendicular to the largest surface area. Therefore, the electrical connector 25 can be stored in the second accommodating slot 117.

The second accommodating slot 117 further comprises a first slot 1171 and a second slot 1173. The first slot 1171 connects to the second slot 1173. The first slot 1171 accommodates the electrical connector 25 and is closed to the second communicating hole 119. The second slot 1173 is disposed at one side of the electrical connector 25 and is away from the second communicating hole 119.

The body 11 further comprises a second communicating opening 1190, one end of which is connected to the second communicating hole 119, and the other end of the opening 1190 extends to the periphery of the body 11 and connects to the annular opening 1130. That is, the second communicating opening 1190 is on the second ring part 130. The electrical connecting cable 23 connected to the electrical connector 25 can further enter the second communicating hole 119 through the second communicating opening 1190. Then the electrical connecting cable 23 connected to the electrical connector 25 is stored in the annular groove. Thus, the electrical connecting cable 23 would not wind around the bottom surface of the body 11.

In addition, the width of the annular opening 1130 can be further reduced. The width of the annular opening 1130 equals to the gap between the first ring part 120 and the second ring part 130, such that the size of the electrical connector 25 is larger than the diameter of the annular opening 1130. The material of the body 11 is elastic such as rubber so that the body 11 is elastically deformable. When the electrical connector 25 passes through the annular slot 1130, the electrical connector 25 expands the annular opening 1130 of the annular groove 113, then the electrical connecting cable 23 is wound on the intermediate winding body 110 in the same way, and details are not described herein. This embodiment reduces the size of the body 11 as described above for portability.

Moreover, the width of the annular opening 1130 can be further reduced. If the outer diameter (i.e., the cable thickness) of the electrical connecting cable 23 is larger than the width of the annular opening 1130, the electrical connecting cable 23 would be restricted by the annular opening 1130 in the case where the electrical connecting cable 23 is not pulled by an external force while the electrical connecting cable 23 is wound through the annular opening 1130 or the second communicating opening 1190. Therefore, the electrical connecting cable 23 could not pass through the annular opening 1130 arbitrarily and is restricted in the annular groove 113 keeping the electrical connecting cable 23 from detaching.

The embodiment can further reduce the width of the second communicating opening 1190. The width of the second communicating opening 1190 equals to the width in the direction in which the annular groove 113 extends. The electrical connecting cable 23 would also be restricted by the second communicating opening 1190 in the case where the electrical connecting cable 23 is not pulled by an external force such that the electrical connecting cable 23 could not pass through the second communicating opening 1190 arbitrarily and is restricted in the second communicating opening 1190. Thus, the electrical connecting cable 23 is restored in the second communicating hole 119.

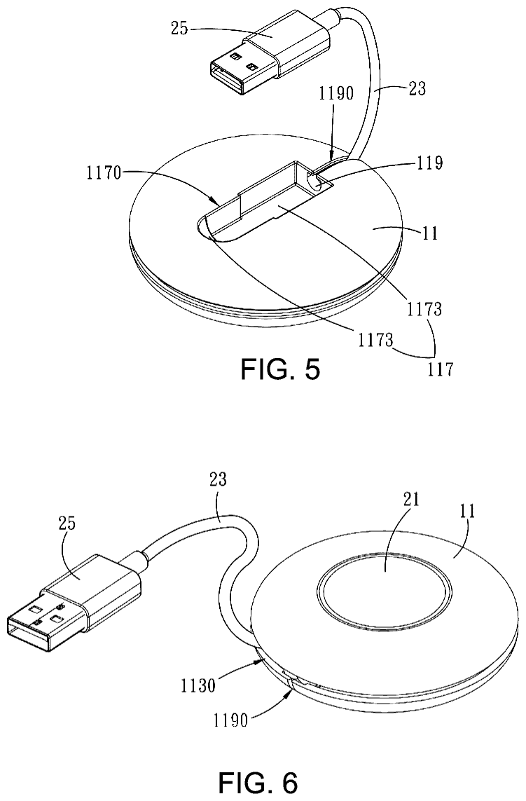

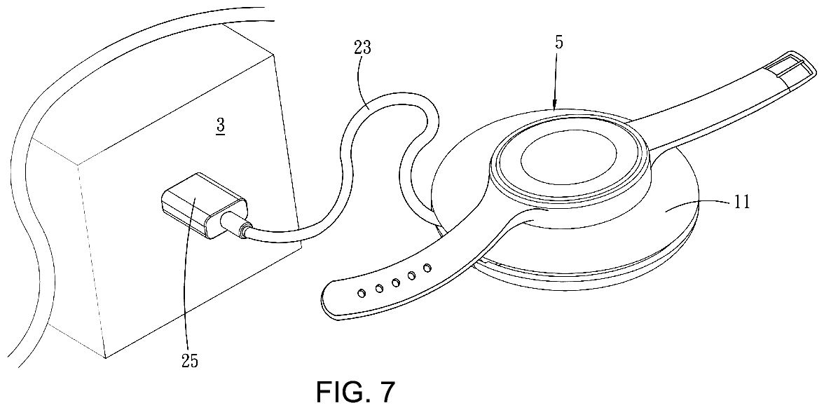

FIG. 5 is a state diagram of the use of a cable organizer of the first embodiment of the present disclosure. FIG. 6 is another state diagram of use of a cable organizer of the first embodiment of the present disclosure. FIG. 7 is a state diagram of charging of a cable organizer of the first embodiment of the present disclosure. As shown in the figures, the electrical connector 25 needs to be removed from the second accommodating slot 117 if the charger 21 needs to be used. The electrical connector 25 can be removed by applying a force to the end surface of the electrical connector 25 through the second slot 1173. The electrical connector 25 connected to electrical connecting cable 23 is removed from the second communicating hole 119 toward the second communicating opening 1190 (as shown in FIG. 5).

The electrical connecting cable 23 can be unwound along with the cable head, that is, the opposite direction of the electrical connecting cable 23 surrounds of the body 11 while the electrical connecting cable 23 is removed from the second communicating opening 1190. After the electrical connecting cable 23 is pulled out from the annular groove 113 toward the annular opening 1130 (as shown in FIG. 6), leave a segment of the electrical connecting cable 23 outside the annular slot 1130 of the body 11 in an appropriate length. Therefore, the electrical connector 25 can be electrically plugged into the power supply 3 through an electrical connecting cable 23 of a suitable length (as shown in FIG. 7).

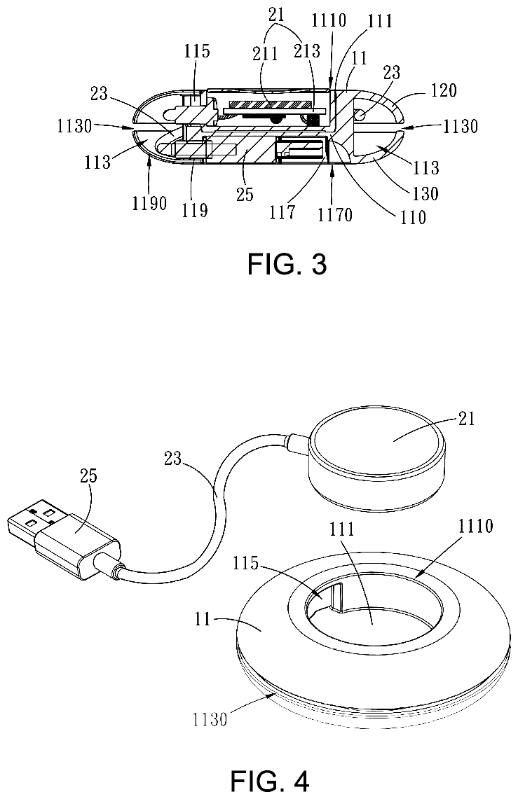

In this embodiment, an electronic device 5 (such as a smartwatch) that needs to be charged is placed on the top of the body 11 and the center of the charger 21, so the electronic device can be wirelessly charged by the wireless charging coil 211 of the charger 21 (shown in FIG. 3).

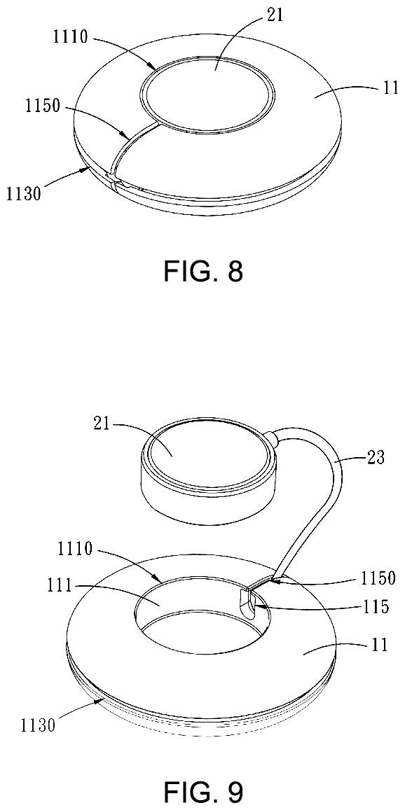

FIG. 8 is a schematic diagram of a cable organizer of the second embodiment of the present disclosure. FIG. 9 is a state diagram of the use of a cable organizer of the second embodiment of the present disclosure. As shown in the figure, the difference between this embodiment and the first embodiment lies in the first communicating opening 1150 connecting the annular opening 1130 and the first slot opening 1110. The first communicating opening 1150 connects to the first communicating hole 115.

In this embodiment, the electrical connecting cable 23 close to the charger 21 can enter the first communicating hole 115 through the first communicating opening 1150, so the charger 21 can be easily removed from the first accommodating slot 111 of the body 11 (as shown in FIG. 9).

Moreover, the electrical connecting cable 23 can enter the first communicating hole 115 through the first communicating opening 1150, so the electrical connector 25 does not need to pass through the first communicating hole 115. The orifice of the first communicating hole 115 does not need to be larger than the outer diameter of the electrical connector 25. Therefore, the orifice of the first communicating hole 115 comprising the first communicating opening 1150 is smaller than that of the first communicating hole 115 without the first communicating opening 1150.

In addition, in this embodiment, the width of the second communicating opening 1190 can be further reduced. The width of the second communicating opening 1190 equals to the gap between the two edges of the first ring part 120. In this embodiment, how the first communicating opening 1150 is reduced is the same as that of the second communicating opening 1190, the effect and purpose of reducing the width of the said two openings 1150 and 1190 are the same, and therefore will not be described again.

In summary, the present disclosure provides a cable organizer making the electrical connecting cable to be neatly arranged without being scattered and making the electrical connecting cable to be easily stored by placing the charger in the first accommodating slot and winding the electrical connecting cable around the body and storing the cable in the annular groove.

It is to be understood that the term “comprises”, “comprising”, or any other variants thereof, is intended to encompass a non-exclusive inclusion, such that a process, method, article, or device of a series of elements not only include those elements but also includes other elements that are not explicitly listed, or elements that are inherent to such a process, method, article, or device. An element defined by the phrase “comprising a . . . ” does not exclude the presence of the same element in the process, method, article, or device that comprises the element.

Although the present invention has been explained in relation to its preferred embodiment, it does not intend to limit the present invention. It will be apparent to those skilled in the art having regard to this present invention that other modifications of the exemplary embodiments beyond those embodiments specifically described here may be made without departing from the spirit of the invention. Accordingly, such modifications are considered within the scope of the invention as limited solely by the appended claims.

What is claimed is:

1. A cable organizer, comprising:
a body comprising a first accommodating slot, an annular groove, and a first communicating hole; the annular groove is disposed along the circumference of the first accommodating slot; the first accommodating slot connects to the annular groove through the first communicating hole;
a charger disposed in the first accommodating slot;
an electrical connecting cable, one end of which is electrically connected to the charger; the other end of the electrical connecting cable enters the annular groove through the first communicating hole; the electrical connecting cable is wound around the body and is stored in the annular groove.

2. The cable organizer according to claim 1, wherein the first accommodating slot comprises a first slot opening disposed at the top surface of the body; the annular groove comprises an annular opening disposed at the circumferential side of the body; the annular opening is disposed around the first slot opening.

3. The cable organizer according to claim 2, wherein the body comprises a first communicating opening connecting the annular opening and the first slot opening; the first communicating opening connects to the first communicating hole.

4. The cable organizer according to claim 2, wherein the outer diameter of the electrical connecting cable is greater than or equal to the width of the annular opening.

5. The cable organizer according to claim 2, wherein the inner diameter of the first slot opening of the first accommodating slot is greater than or equal to the outer diameter of the charger; the height of the first accommodating slot is higher than or equal to the height of the charger, making the charger to be stored in the first accommodating groove.

6. The cable organizer according to claim 1, wherein the body comprises a second accommodating slot and a second communicating hole; the second accommodating slot comprises a second slot opening disposed on the bottom surface of the body;
the second accommodating slot connects to the annular groove through the second communicating hole; wherein the second accommodating slot accommodates an electrical connector connected to the other end of the electrical connecting cable.

7. The cable organizer according to claim 6, wherein the cross-sectional area of the electrical interface of the electrical connector in the insertion direction is less than or equal to the orifice of the first communicating hole.

8. The cable organizer according to claim 6, comprising:
a second communicating opening connecting the annular opening and the second slot opening; the second communicating opening connects to the second communicating hole.

9. The cable organizer according to claim 8, wherein the cross-sectional area of the electrical interface of the electrical connector in the insertion direction is less than or equal to the orifice of the second communicating hole.

10. The cable organizer according to claim 6, wherein the second slot opening of the second accommodating slot is greater than or equal to the largest side surface area of the electrical connector; the height of the second accommodating slot is greater than or equal to the height of the electrical connector in a direction perpendicular to the largest surface area.

11. The cable organizer according to claim 6, wherein the second accommodating slot comprises a first slot and a second slot; the first slot connects to the second slot; the first slot accommodates the electrical connector; the second slot is on one side of the electrical connector.
